(19) United States
(12) Patent Application Publication
(10) Pub. No.: US 2013/0159034 A1
(43) Pub. Date: Jun. 20, 2013

(54) BUSINESS PROCESS GUIDE AND RECORD

(71) Applicants: Klaus Herter, Leimen (DE); Arno Mielke, Karlsruhe (DE)

(72) Inventors: Klaus Herter, Leimen (DE); Arno Mielke, Karlsruhe (DE)

(21) Appl. No.: 13/326,270

(22) Filed: Dec. 14, 2011

(51) Int. Cl. G06Q 10/06

(52) U.S. Cl. 705/7.11

(57) ABSTRACT

Business process guidance and recording features can provide a user with seamless, integrated guidance through a business process while recording concrete instances of the business process to allow context sensitive navigation of process instances. Process steps required for completion of a business process, feature modules of a business software architecture whose functionality relates to a specific process step, and an execution order for the process steps can be defined. Work and business process guidance frames can be concurrently displayed via a user interface. The guidance frame can include user interface element corresponding to one of the process steps and indicating a current status of that process step for a selected business process instance. Upon user selection of a user interface element corresponding to the specific process step, the work frame can display a workspace including another user interface element corresponding to the functionality of a related feature module.

### CROSS-REFERENCE TO RELATED APPLICATIONS

The current application is related to the following co-pending and co-owned U.S. patent applications, the disclosure of each of which is incorporated herein in its entirety: [[Attorney docket nos. 34874-760F01US/2011P00149US, 34874-761F01US/2011P00163US, 34874-763F01US/2011P00166US, 34874-764F01US/2011P00167US, 34874-765F01US/2011P00168US, 34874-766F01US/2011P00169US, 34874-768F01US/2011P00171US, 34874-769F01US/2011P00172US, 34874-770F01US/2011P00173US, 34874-771F01US/2011P00174US, 34874-772F01US/2011P00175US, 34874-773F01US/2011P00198US, and 34874-781F01US/2011P00363US]].

### TECHNICAL FIELD

The subject matter described herein relates generally to enhancing user interaction with, and navigation among, features, functions, controls, and the like of an integrated software suite, such as for example an enterprise resource planning solution. In particular implementations, the current subject matter can provide a user with seamless, integrated guidance through a business process while recording concrete instances of the business process to allow context sensitive navigation of each individual instance.

### BACKGROUND

The definition, adaptation and execution of business processes, particularly complicated business processes that require access to multiple systems or applications, that require completion of tasks by multiple persons or business units, and/or that involve one or more tasks or sub-processes that are performed external to an enterprise resource planning (ERP) program or other business software architecture (e.g. placing a reminder phone call to a vendor or employee, filing hard copies of completed forms in physical files, etc.) can present a variety of challenges to a business user. For example, navigating through a complicated business process defined within an ERP environment can be time consuming and difficult, especially in a small to mid-sized business in which one person may have several roles and many different tasks across a chain of business processes.

Conventional ERP systems and their associated user interface features are often directed to support standalone transactions with specific key capabilities without necessarily providing a user with convenient access to information about how these capabilities fit into one or more specific instances of a business process, which can include multiple transactions, tasks, or sub-processes composed of multiple tasks or transactions. A work center, which can be customized or adapted to specific users or specific user roles, may not provide a user having multiple roles with sufficient context to be able to efficiently determine how the provided capabilities are included within a business process related workflow. Workflow items can include specific tasks that are delegated to a user to compose activities of a business process. Features such as a business adaption catalog or the like can provide a view based on a specific business scenario or process but is generally limited to a design time view on a business process template that is not readily viewable by an end user and that cannot reflect run time modifications or progress toward completion of the overall process or of specific sub-processes or tasks within the process.

Work lists or task lists can be used to collect business objects of similar type (e.g. sales orders, etc.) to provide an improved overview of the types of tasks that are available for a user to perform. However, the user may still need to know how these business objects interact with other process steps related to the business objects. Document flow diagrams allow the business user a retro perspective of how a business process was executed including the instances of the involved business object instances. Such an approach can be process centric but only in retrospect. In other words, while a static, retrospective view of an already-executed business process can provide some helpful information, such a view cannot indicate how far toward completion a currently in-progress business process is, nor can it provide information relating to potential delays or instance-specific issues that can affect completion of the process instance. Additionally, such an approach cannot provide a live guide for next steps of a current process instance.

Currently available approaches can be insufficient for a fully efficient use of the features of an ERP system or other business software architecture. For example, a user may require a comprehensive understanding of whether and how various business entities of different work lists fit together. Other difficulties may also arise when a user wants to contact another person who has responsibility for completion of a subsequent or prior step or sub-process in a business process, for example to obtain further information. Such functionality is generally not readily accessible via either a list of process functions, ERP system capabilities, or the like that are available to the user or via a task list showing business objects accessible to the user or requiring the user's attention.

### SUMMARY

In one aspect, a method includes accessing a definition of a business process that includes a designation of a plurality of process steps required for completion of the business process, one or more feature modules of an enterprise resource planning software system providing functionality relating to a specific process step of the plurality of process steps, and an order in which the plurality of process steps are to be executed. At least two of the plurality of process steps require action by different feature modules of the enterprise resource planning software system. A work frame and a business process guidance frame are concurrently displayed via a user interface presented on a computer display device. The business process guidance frame includes a first plurality of user interface elements arranged within the business process guidance frame. Each the first plurality of user interface elements corresponds to one of the plurality of process steps and provides an indication of a current status of the corresponding one of the plurality of process steps for a selected instance of the business process. A user selection of one of the first plurality of user interface elements corresponding to the specific process step is received, and a user workspace that includes second plurality of user interface elements corresponding to the functionality provided by the one or more feature modules of the enterprise resource planning software system that is related to the specific process step is displayed in the work frame.

In some variations one or more of the following can optionally be included. At least one of the plurality of process steps can optionally include a sub-process comprising additional process steps, and a second selection of the one of the first plurality of user interface elements corresponding to the sub-process can optionally result in expansion of the one of the first plurality of user interface elements to display an additional first user interface element corresponding to each of the additional process steps. The definition can optionally include a business object stored in a database. The current status can optionally include at least one of which process steps have already been already performed for the selected instance of the business process, a link to a concrete instance of at least one business objects containing data relevant to one or more process steps or sub-processes of the selected instance of the business process, a name or identity of one or more responsible users, and one or more users with supervisory roles or other gatekeeper roles relating to the business process.

The method can optionally further include receiving, via a second user interface, a change to the definition of the business process. The change can optionally include one or more of rearrangement of an order of two or more of the plurality of process steps, addition of a new process step, deletion of one of the plurality of process steps, and re-definition of an aspect of one of the plurality of process steps. The received change can optionally be saved to the definition. The definition can optionally include a business object stored in a database. The business object can optionally include a template of a standard version of the business process, and the change can optionally be stored as an extension to the business object.

Systems and methods consistent with this approach are described as well as articles that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

Implementations of the current subject matter can provide one or more advantages. For example, a combined process visualization, guidance, and navigation tool can provide visualization of customer-specific business processes that are based on packaged, predefined process templates delivered by the ERP vendor and presented in the business language of the customer. The predefined business processes can be changed, extended, created, or the like to create customer-specific combinations of well-defined applications with one or more steps or sub-processes that are performed by one or more users. Processes can be changed, extended, or otherwise modified by a customer (e.g. by an individual user in some examples or by a key user with sufficient access rights). Process guidance can be provided in an integrated manner while a current (e.g. in-progress or otherwise not yet completed) live instance of the business process is being executed. An overview of the business process can be provided that informs a user what the next process steps or other business process features (e.g. tasks, activities, etc.) are from the current process step. The way in which one or more users work on a specific process instance can be recorded as can the relationships of business object instances corresponding to a specific process instance. Manual steps (e.g. business process features that are performed offline or otherwise outside of the business software architecture of ERP system) can also optionally be included within the business process guide and/or business process instance record features of implementations of the current subject matter.

It should be noted that, while the descriptions of specific implementations of the current subject matter discuss delivery of enterprise resource planning software to multiple organizations via a multi-tenant system, the current subject matter is applicable to other types of software and data services access as well. The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows an example of a business process whose completion involves actions by several departments and users;

FIG. 2 is a process flow diagram illustrating aspects of a method having one or more features consistent with implementations of the current subject matter;

FIG. 3 depicts an example of a user interface view;

FIG. 4 is a diagram illustrating aspects of a system showing features consistent with implementations of the current subject matter;

FIG. 5 is a diagram illustrating aspects of a system showing features consistent with implementations of the current subject matter; and

FIG. 6 is a diagram illustrating a data repository showing features consistent with implementations of the current subject matter.

When practical, similar reference numbers denote similar structures, features, or elements.

### DETAILED DESCRIPTION

As noted above, conventional ERP systems typically focus on a user centric approach, for example with customizable or semi-customizable user-specific screens that can be tailored to provide easy access to tasks and functions that are assigned to a given user or otherwise within that user's area of recurring responsibility. However, such an approach may not provide a convenient way to readily identify how a given task or sub-process relates to other tasks or sub-processes involved in completion of a business process. Additionally, in some business environments, a single employee or other ERP system user may have responsibilities that bridge multiple different processes that do not relate to one another. Keeping track of the progress of a specific instance of a business process may require the user to search in multiple different user interface screens (which are generally referred to herein as “work centers”), take note of process instance identifiers, search for one or more general templates on which the process instance is based to determine other tasks and sub-processes that may be related to the process instance, and in some examples even conduct discussions with one or more local or remote experts or consultants. Such an approach is not efficient and can lead to errors, redundancies, and the like.

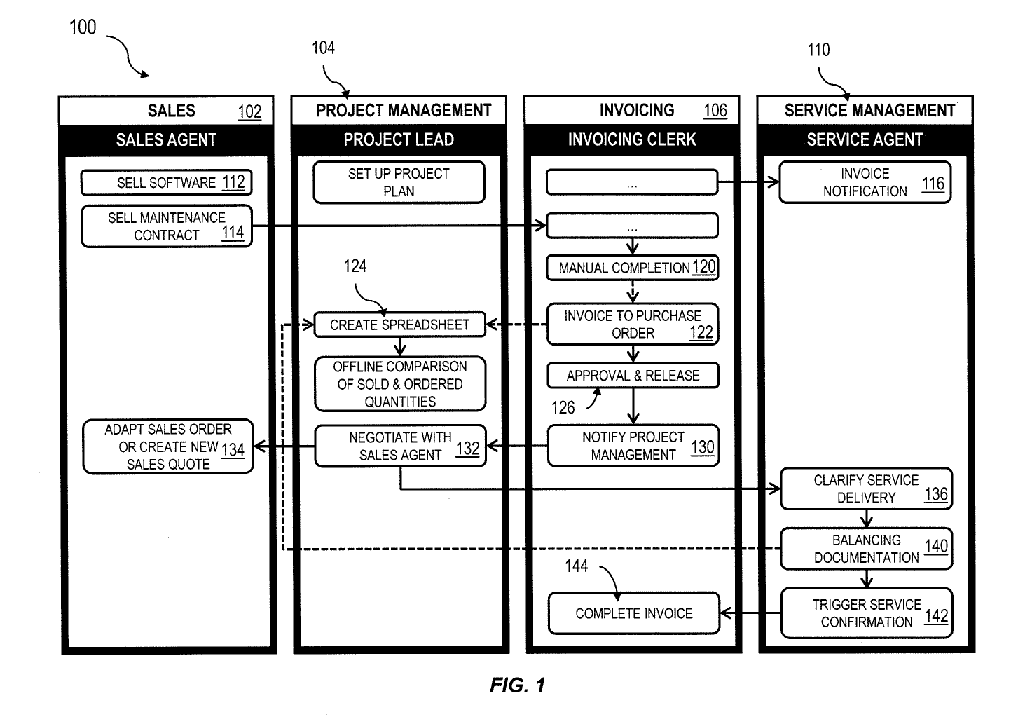

An illustrative and non-limiting example of a business process that can include multiple users within an organization performing a number of tasks that are interrelated and require execution in a sequence that is not directly sequential from the perspective of any one user is shown in the flow diagram 100 of FIG. 1. The example illustrated in FIG. 1 is a software sales and support business process involving sales 102 (e.g. by a sales agent user), project management 104 (e.g. by a project lead user), invoicing 106 (e.g. by an invoicing clerk user), and service management 110 (e.g. by a service management user) functions. The sales agent can perform the task of selling the software 112 as well as selling a maintenance contract 114. The invoicing clerk can have assigned tasks associated with these sales that includes providing an invoice notification 116 to the service agent and manual completion 120 of one or more fields relating to an invoice relating to the software and/or maintenance contract sales 112, 114 prior to completion of an invoice to purchase order step 122 that can prompt creation of a project management sheet 124 (e.g. a spreadsheet) by the project lead. The invoicing clerk can also proceed in parallel with steps relating to approval and release 126 of the invoice or purchase order and providing notification 130 of the project management function to negotiate 132 with the sales agent regarding any necessary adaptations to the existing sales order or creation of new sales orders 134 related, for example to customization of the software. The negotiating with the sales agent step 132 can also include clarifying service delivery requirements 136 to the service management function. The clarifying of the service delivery requirements can trigger the need for balancing out the software documentation 140, for example to reflect any customizations as well as providing confirmation of the service agreement terms 142. The balancing of documentation 140 can feed back into the project management spreadsheet 124. The invoicing function can follow with completion of the invoice 144.

Any one of the ERP users participating in the business process illustrated in FIG. 1 may be unable to accurately track the status of all process steps and sub-processes involved in proper completion of the business process. For example, the sales clerk user may be provided with a task list of sales orders and corresponding invoices that need to be generated. However, he or she may not be able to readily identify a status of other tasks involved in the completion of the business process or to determine the cause of an interruption or other delay in the process. For example, if a purchase order is awaiting approval and release 126 by a different authorized user (e.g. a supervisor), the invoicing clerk may not know that this is where a specific instance of the process has been delayed. If a sales agent contacts the invoicing clerk to request a status update, the invoicing clerk may only be able to reply that he or she has sent the invoice or purchase order for approval and release without knowing for certain where the process has been interrupted.

To address one or more of these or other potential issues with currently available solutions, implementations of the current subject matter can, among other possible advantages, provide a process-centric view that gives an overview of a business process, which can include a sequential view of the process steps or sub-processes involved in completion of the business process as well as progress in completing those process steps and/or sub-processes for a specific instance of the business process. A combined process visualization, guidance, and navigation tool consistent with one or more implementations of the current subject matter can provide visualization of customer-specific business processes that are based on packaged, predefined process templates delivered by the ERP vendor and/or defined by on-site consultants or other key users. and presented in the business language of the customer. A predefined business processes can be changed, extended, created, or the like to create customer-specific combinations of well-defined applications with one or more process steps or sub-processes that contain one or more of such process steps for execution by one or more users. Processes can be changed, extended, or otherwise modified by a customer (e.g. by an individual user in some examples or by a key user with sufficient access rights).

In some implementations, modifications to a process template to reflect customer-specific features of a customized business process can be performed via “drag and drop” or some other user-interface interactive functionality via which user interface elements or screens can be linked to icons or other user interface elements in a business process guidance pane to enable rapid navigation throughout a specific instance of a business process. As used herein, the term “instance of a business process” and similar descriptive terminology is intended to refer to a specific execution of the business process. For example, for a business process relating to sale of a product, each order taken and filled for that product can be considered as an instance of the business process. The term “business configuration” refers to a set of business processes supported by the business software architecture and optionally customized to reflect the actual, real-life business functions (e.g. end-to-end business processes) performed by employees or other organization members on a recurring basis. A business configuration for an organization customer of a business software architecture is usually set up upon initial installation with occasional modifications or updates provided to reflect changes to the underlying real-life processes and procedures. Such a business configuration is typically constructed like a catalog, and its functions can be structured according to business areas, packages, topics and options. Once the initial business configuration is set up, all decisions are made, and the scoping is done, the business software architecture is ready for productive usage.

The linked user interface elements or screens can be displayed in a work pane (e.g. a separate box, region, space, etc. of a user interface displayed to a user via one or more computer display devices) that is displayed concurrently with the business process guidance pane. These linked user interface elements or screens can include, but are not limited to, work center screens or elements thereof, reports, work center floor plans (e.g. a higher level view containing user interface navigation elements that link to one or more other screens or elements), text elements, graphical or textual user interface elements linking to extended functionality (e.g. functionality provided by a third party vendor that is not fully integrated into a core platform of an ERP or business software suite, manual or semi-manual tasks such as phone calls or the like that are part of the ERP or business software suite, tasks or parts thereof that require use of standalone software programs such as word processors or spreadsheets or the like, etc.) for manual extensions, to fill process gaps and for manual extensions or deviations from a pre-defined or “template” business process.

Consistent with one or more implementations, run time user interface elements can be supported by an underlying business object defined at design time to comply with a generic business process template. For each instance or set of instances of a given business process, the business object can be modified via user interface interactions to enable customizations that reflect one or more customer-specific business process aspects. The underlying business object can provide the basis for user interface elements that act as a visual guide or map through a general template or scheme illustrating process steps and/or sub-processes within a business process and how the various process steps and/or sub-processes are sequentially related. These user interface elements can reflect details regarding completed and to-be-completed sub-processes and steps. A user interface element representing a specific process, sub-process, task, or other aspect of a business process can be expandable to show additional granularity of underlying sub-processes or steps.

In some implementations, a design time modification engine can be implemented to enable business process configuration and customization via drag and drop or other user interface features that permit rearrangement, addition, deletion, etc. of feature of a business process (sub-processes, related business processes, steps, tasks, etc.).

In addition, when running a business process, (e.g. make to stock, make to order, sell service, procure, etc.) implementations of the current subject matter can provide, for a business user, a convenient and user-friendly mechanism for verifying a current completion status of the business process. For example, a business user can be provided with a visual display, for example in a business process guidance pane of a user interface, which indicates what stage or process step of a specific instance of the business process is currently under way. whether a product is already in production, which invoices have been posted, whether a telephone call with the technical department has already occurred, or the like.

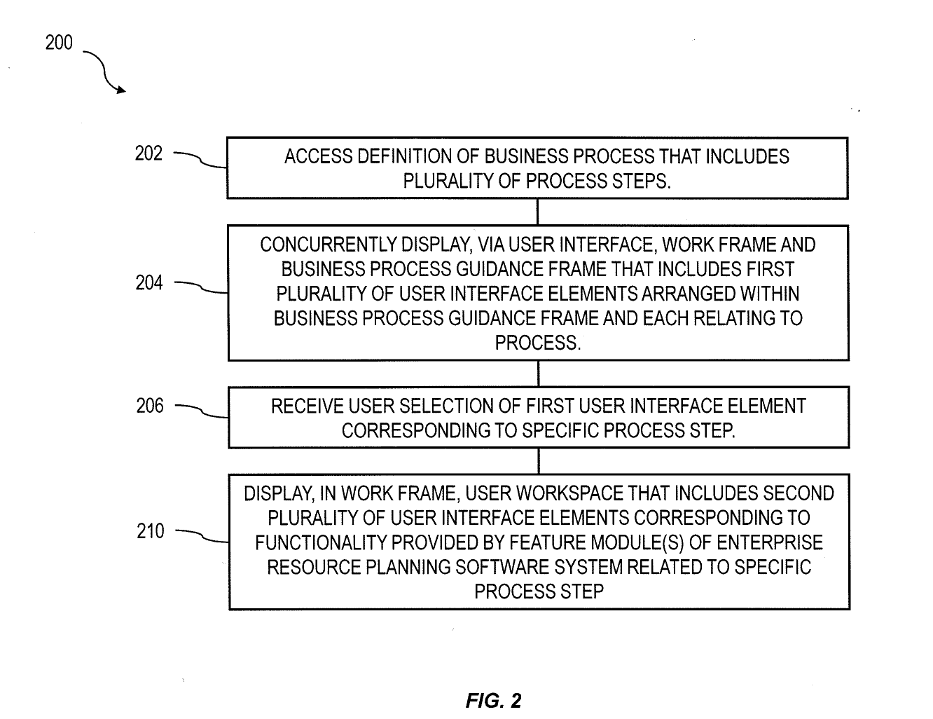

A method consistent with implementations of the current subject matter can include one or more of the features illustrated in the process flow chart 200 of FIG. 2. At 202, a definition of a business process is accessed. The definition can include designation of a plurality of process steps required for completion of the business process, one or more feature modules of an enterprise resource planning (ERP) software system providing functionality relating to a specific process step of the plurality of process steps, and an order in which the plurality of process steps are to be executed. In some implementations, at least two of the plurality of process steps can require action by different feature modules of ERP software system.

At 204, a work frame and a business process guidance frame can be displayed concurrently via a user interface presented on a computer display device. The business process guidance frame can include a first plurality of user interface elements arranged within the business process guidance frame. Each the first plurality of user interface elements can correspond to one of the plurality of process steps. Each of the first plurality of user interface elements can further provide an indication of a current status of the corresponding one of the plurality of process steps for a selected instance of the business process.

Continuing with reference to FIG. 2, a user selection of one of the first plurality of user interface elements corresponding to the specific process step is received at 206, and a user workspace is displayed in the work frame at 210. The user workspace can include a second plurality of user interface elements corresponding to the functionality provided by the one or more feature modules of the enterprise resource planning software system that is related to the specific process step.

A conventional process monitor that may be provided with existing ERP software is typically designed for monitoring to provide information required for handling and resolving of “exceptions, such as for example issues that require a deviation from the typical protocol for completing a specific step of a business process (e.g. a custom order for a non-standard product, an expedited delivery request, etc.). Accordingly, the typical design of such monitor revolves around streamlining document flow for identifying financial postings and documents related to such issues. In contrast, one or more implementations of the current subject matter can provide a business process recording feature that records how a specific instance of a business process is actually executed without being directly fixed to a structure of the underlying business process template. In other words, the business process recording feature can be accessed during or after completion of the specific instance to graphically or otherwise display how the various process steps and/or sub-processes were actually completed by the users who participated in completion of the process steps or sub-processes.

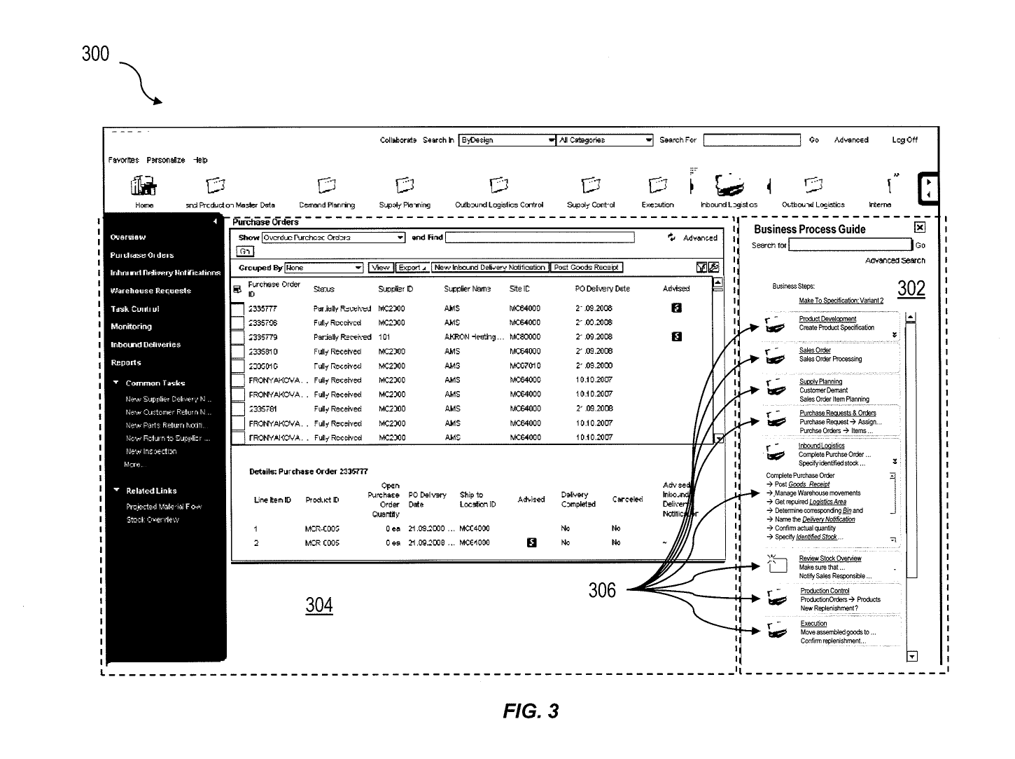

FIG. 3 shows an example of a user interface layout 300 in which a business process guidance pane 302 is located in the right column and a work pane 304 is located on the left side of the screen. Within the business process guidance pane 302 are shown several user first user interface elements 306 that correspond to process tasks or sub-processes of a business process and to a specific instance of the business process. Selection of one of the first user interface elements 306 causes content (e.g. second user interface elements) to be displayed in the work pane 304. The displayed content relates to the process step or sub-process corresponding to the selected first user interface element 306. While an instance of the business process is in progress, or alternatively after the instance is completed, each first user interface element 306 can provide information that can include one or more of status information to show which process steps have already been already performed, links to concrete instances of business objects containing data relevant to a specific process step or sub-process, (e.g. order number, customer identifiers or locations, etc.), name or identity of one or more responsible users, one or more users with supervisory roles or other gatekeeper roles relating to the business process, due date, or the like. Individual first user interface elements 306 can be expandable upon being selected to show additional information.

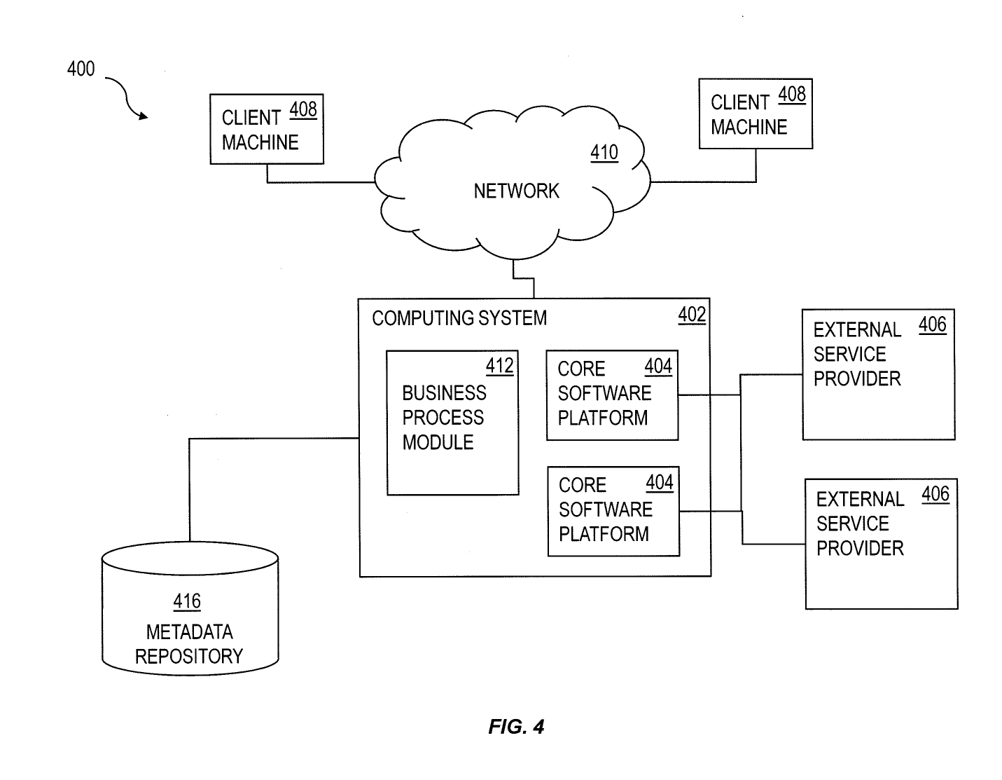

The core software platform of an ERP or other business software architecture can be provided as a standalone, customized software installation that runs on one or more processors that are under the control of the organization. This arrangement can be very effective for a large-scale organization that has very sophisticated in-house information technology (IT) staff and for whom a sizable capital investment in computing hardware and consulting services required to customize a commercially available ERP solution to work with organization-specific business processes and functions is feasible. FIG. 4 shows a diagram of a system consistent with such an implementation. A computing system 402 can include one or more core software platform modules 404 providing one or more features of the ERP system. The computing system can also aggregate or otherwise provide a gateway via which users can access functionality provided by one or more external service providers 406. Client machines 408 can access the computing system, either via a direct connection, a local terminal, or over a network 410 (e.g. a local area network, a wide area network, a wireless network, the Internet, or the like). A business process guidance and recording module 412 can be hosted on the computing system 402 or alternatively, on an external system accessible over a network connection. The business process guidance and recording module 412 can optionally include one or more discrete software and/or hardware modules that perform operations such as those described herein.

The business process guidance and recording module 412 can access one or more metadata repositories 416 and/or other data repositories that can store the definition of business process as well as data relating to concrete instances of the data objects (e.g. business objects) that are relevant to a specific instance of the business process. In some examples, the definition can optionally be stored as a business object. In some implementations, the business object can include a template definition of a standard business process. The template definition that can optionally be modified via one or more extensions that are stored in the one or more metadata repositories 416.

Smaller organizations can also benefit from use of ERP functionality. However, such an organization may lack the necessary hardware resources, IT support, and/or consulting budget necessary to make use of a standalone ERP software architecture product and can in some cases be more effectively served by a software as a service (SaaS) arrangement in which the ERP system architecture is hosted on computing hardware such as servers and data repositories that are maintained remotely from the organization's location and accessed by authorized users at the organization via a thin client, such as for example a web browser, over a network.

In a software delivery configuration in which services of an ERP system are provided to each of multiple organizations are hosted on a dedicated system that is accessible only to that organization, the software installation at the dedicated system can be customized and configured in a manner similar to the above-described example of a standalone, customized software installation running locally on the organization's hardware. However, to make more efficient use of computing resources of the SaaS provider and to provide important performance redundancies and better reliability, it can be advantageous to host multiple tenants on a single system that includes multiple servers and that maintains data for all of the multiple tenants in a secure manner while also providing customized solutions that are tailored to each tenant's business processes.

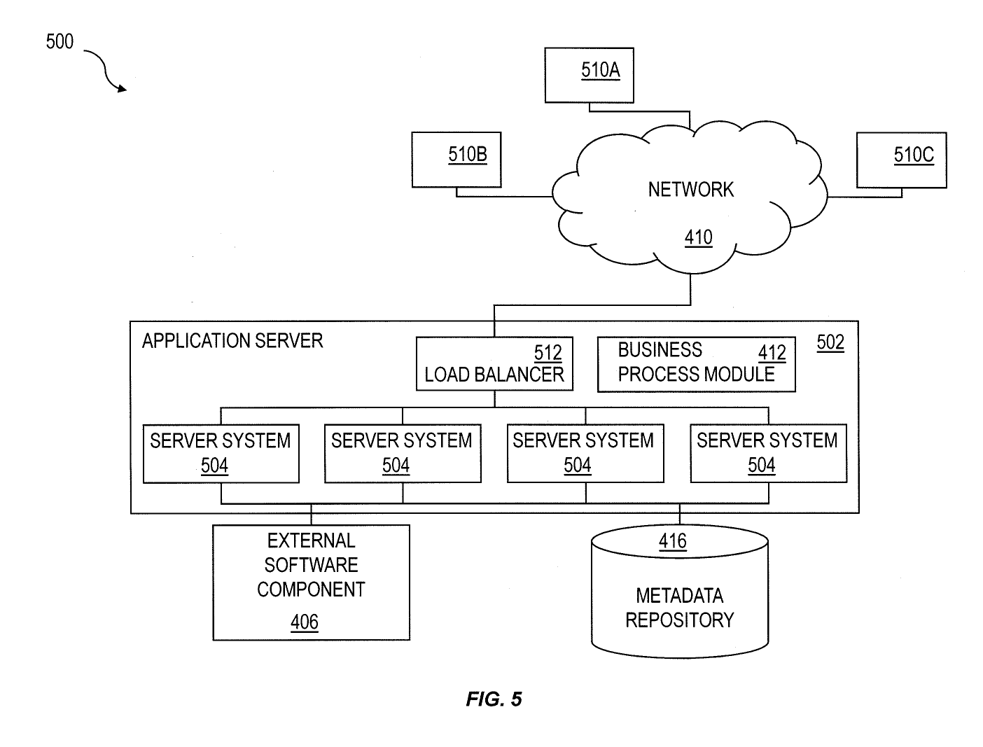

FIG. 5 shows a block diagram of a multi-tenant implementation of a software delivery architecture 500 that includes an application server 502, which can in some implementations include multiple server systems 504 that are accessible over a network 506 from client machines operated by users at each of multiple organizations 510A-510C (referred to herein as “tenants” of a multi-tenant system) supported by a single software delivery architecture 500. For a system in which the application server 502 includes multiple server systems 504, the application server can include a load balancer 512 to distribute requests and actions from users at the one or more organizations 510A-510C to the one or more server systems 504. Instances of the core software platform 404 (not shown in FIG. 5) can be executed in a distributed manner across the server systems 504. A user can access the software delivery architecture across the network using a thin client, such as for example a web browser or the like, or other portal software running on a client machine. The application server 502 can access data and data objects stored in one or more data repositories 416. The application server 502 can also serve as a middleware component via which access is provided to one or more external software components 406 that can be provided by third party developers.

A multi-tenant system such as that described herein can include one or more of support for multiple versions of the core software and backwards compatibility with older versions, stateless operation in which no user data or business data are retained at the thin client, and no need for tenant configuration on the central system. As noted above, in some implementations, support for multiple tenants can be provided using an application server 502 that includes multiple server systems 504 that handle processing loads distributed by a load balancer 512. Potential benefits from such an arrangement can include, but are not limited to, high and reliably continuous application server availability and minimization of unplanned downtime, phased updating of the multiple server systems 504 to permit continuous availability (one server system 504 can be taken offline while the other systems continue to provide services via the load balancer 512), scalability via addition or removal of a server system 504 that is accessed via the load balancer 512, and de-coupled lifecycle processes (such as for example system maintenance, software upgrades, etc.) that enable updating of the core software independently of tenant-specific customizations implemented by individual tenants.

As in the example illustrated in FIG. 4, the metadata repository 416 can store a business object that represents a template definition of a standard business process. Each individual tenant 510A-510C can customize that standard template according to the individual business process features specific to business of the organization to which that tenant is assigned. Customizations can be stored as extensions in the metadata repository.

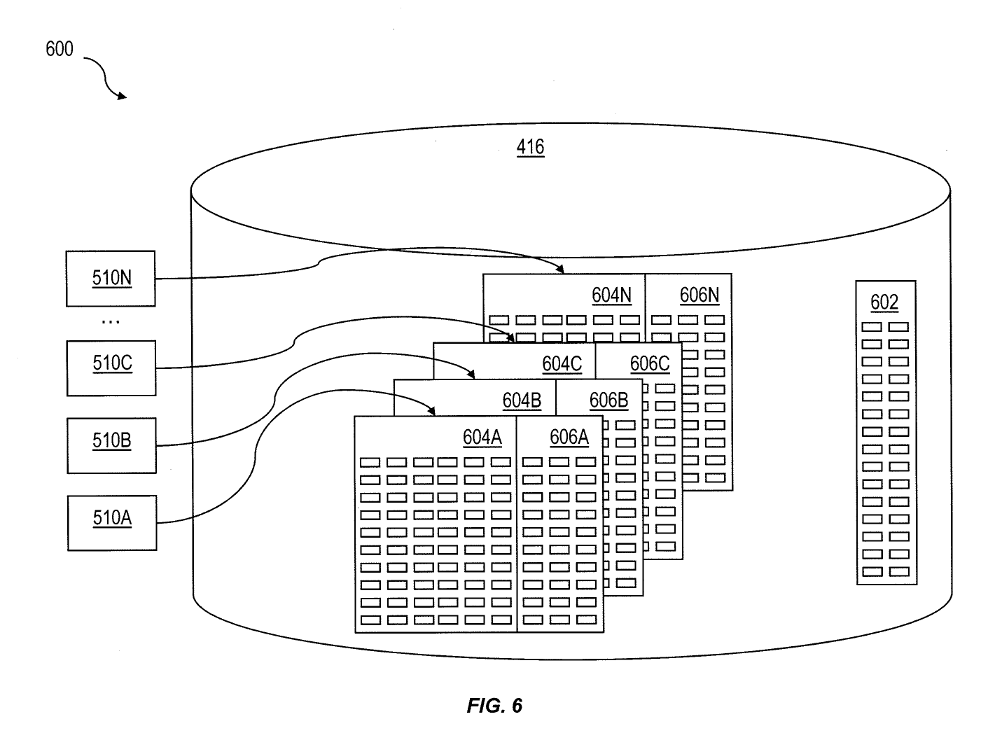

To provide for customization of the business process for each of multiple organizations supported by a single software delivery architecture 500, the data and data objects stored in the metadata repository 416 and/or other data repositories that are accessed by the application server 502 can include three types of content as shown in FIG. 6: core software platform content 602 (e.g. a standard definition of a business process), system content 604 (e.g., and tenant content 606. Core software platform content 602 includes content that represents core functionality and is not modifiable by a tenant. System content 604 can in some examples be created by the runtime of the core software platform and can include core data objects that store concrete data associated with specific instances of a given business process and that are modifiable with data provided by each tenant. The data retained in these data objects are tenant-specific: for example, each tenant 510A-510N can store information about its own inventory, sales order, etc. Tenant content 606A-606N includes data objects or extensions to other data objects that are customized for one specific tenant 510A-510N to reflect business processes and data that are specific to that specific tenant and are accessible only to authorized users at the corresponding tenant. Such data objects can include a key field (for example “client” in the case of inventory tracking) as well as one or more of master data, business configuration information, transaction data or the like. For example, tenant content 606 can reflect tenant-specific modifications or changes to a standard template definition of a business process as well as tenant-specific customizations of the business objects that relate to individual process step (e.g. records in generated condition tables, access sequences, price calculation results, other tenant-specific values, or the like). A combination of the software platform content 602 and system content 604 and tenant content 606 of a specific tenant are accessed to provide the business process definition and/or the status information relating to a specific instance of the business process according to customizations and business data of that tenant such that each tenant is provided access to a customized solution whose data are available only to users from that tenant.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed:

1. A computer program product comprising a machine-readable medium storing instructions that, when executed by at least one programmable processor, cause the at least one programmable processor to perform operations comprising:
accessing a definition of a business process, the definition comprising a designation of a plurality of process steps required for completion of the business process, one or more feature modules of an enterprise resource planning software system providing functionality relating to a specific process step of the plurality of process steps, and an order in which the plurality of process steps are to be executed, at least two of the plurality of process steps requiring action by different feature modules of the enterprise resource planning software system;
displaying, concurrently via a user interface presented on a computer display device, a work frame and a business process guidance frame, the business process guidance frame comprising a first plurality of user interface elements arranged within the business process guidance frame, each the first plurality of user interface elements corresponding to one of the plurality of process steps, each of the first plurality of user interface elements further providing an indication of a current status of the corresponding one of the plurality of process steps for a selected instance of the business process;
receiving a user selection of one of the first plurality of user interface elements corresponding to the specific process step;
displaying, in the work frame, a user workspace comprising a second plurality of user interface elements corresponding to the functionality provided by the one or more feature modules of the enterprise resource planning software system that is related to the specific process step.

2. A computer program product as in claim 1, wherein at least one of the plurality of process steps comprises a sub-process comprising additional process steps, and wherein a second selection of the one of the first plurality of user interface elements corresponding to the sub-process results in expansion of the one of the first plurality of user interface elements to display an additional first user interface element corresponding to each of the additional process steps.

3. A computer program product as in claim 1, wherein the definition comprises a business object stored in a database.

4. A computer program product as in claim 1, wherein the operations further comprise:
receiving, via a second user interface, a change to the definition of the business process, the change comprising one or more of rearrangement of an order of two or more of the plurality of process steps, addition of a new process step, deletion of one of the plurality of process steps, and re-definition of an aspect of one of the plurality of process steps; and
saving the change to the definition.

5. A computer program product as in claim 4, wherein the definition comprises a business object stored in a database, the business object comprising a template of a standard version of the business process, and the change is stored as an extension to the business object.

6. A computer program product as in claim as in claim 1, wherein the current status comprises at least one of which process steps have already been already performed for the selected instance of the business process, a link to a concrete instance of at least one business objects containing data relevant to one or more process steps or sub-processes of the selected instance of the business process, a name or identity of one or more responsible users, and one or more users with supervisory roles or other gatekeeper roles relating to the business process.

7. A system comprising:
at least one programmable processor; and
a machine-readable medium storing instructions that, when executed by the at least one processor, cause the at least one programmable processor to perform operations comprising:
accessing a definition of a business process, the definition comprising a designation of a plurality of process steps required for completion of the business process, one or more feature modules of an enterprise resource planning software system providing functionality relating to a specific process step of the plurality of process steps, and an order in which the plurality of process steps are to be executed, at least two of the plurality of process steps requiring action by different feature modules of the enterprise resource planning software system;
displaying, concurrently via a user interface presented on a computer display device, a work frame and a business process guidance frame, the business process guidance frame comprising a first plurality of user interface elements arranged within the business process guidance frame, each the first plurality of user interface elements corresponding to one of the plurality of process steps, each of the first plurality of user interface elements further providing an indication of a current status of the corresponding one of the plurality of process steps for a selected instance of the business process;
receiving a user selection of one of the first plurality of user interface elements corresponding to the specific process step;
displaying, in the work frame, a user workspace comprising a second plurality of user interface elements corresponding to the functionality provided by the one or more feature modules of the enterprise resource planning software system that is related to the specific process step.

8. A system as in claim 7, wherein at least one of the plurality of process steps comprises a sub-process comprising additional process steps, and wherein a second selection of the one of the first plurality of user interface elements corresponding to the sub-process results in expansion of the one of the first plurality of user interface elements to display an additional first user interface element corresponding to each of the additional process steps.

9. A system as in claim 7, wherein the definition comprises a business object stored in a database.

10. A system as in claim 7, wherein the operations further comprise:
receiving, via a second user interface, a change to the definition of the business process, the change comprising one or more of rearrangement of an order of two or more of the plurality of process steps, addition of a new process step, deletion of one of the plurality of process steps, and re-definition of an aspect of one of the plurality of process steps; and
saving the change to the definition.

11. A system as in claim 10, wherein the definition comprises a business object stored in a database, the business object comprising a template of a standard version of the business process, and the change is stored as an extension to the business object.

12. A system as in claim 7, wherein the current status comprises at least one of which process steps have already been already performed for the selected instance of the business process, a link to a concrete instance of at least one business objects containing data relevant to one or more process steps or sub-processes of the selected instance of the business process, a name or identity of one or more responsible users, and one or more users with supervisory roles or other gatekeeper roles relating to the business process.

13. A method comprising:
accessing a definition of a business process, the definition comprising a designation of a plurality of process steps required for completion of the business process, one or more feature modules of an enterprise resource planning software system providing functionality relating to a specific process step of the plurality of process steps, and an order in which the plurality of process steps are to be executed, at least two of the plurality of process steps requiring action by different feature modules of the enterprise resource planning software system;
displaying, concurrently via a user interface presented on a computer display device, a work frame and a business process guidance frame, the business process guidance frame comprising a first plurality of user interface elements arranged within the business process guidance frame, each the first plurality of user interface elements corresponding to one of the plurality of process steps, each of the first plurality of user interface elements further providing an indication of a current status of the corresponding one of the plurality of process steps for a selected instance of the business process;
receiving a user selection of one of the first plurality of user interface elements corresponding to the specific process step;
displaying, in the work frame, a user workspace comprising a second plurality of user interface elements corresponding to the functionality provided by the one or more feature modules of the enterprise resource planning software system that is related to the specific process step.

14. A method in claim 13, wherein at least one of the plurality of process steps comprises a sub-process comprising additional process steps, and wherein a second selection of the one of the first plurality of user interface elements corresponding to the sub-process results in expansion of the one of the first plurality of user interface elements to display an additional first user interface element corresponding to each of the additional process steps.

15. A method in claim 13, wherein the definition comprises a business object stored in a database.

16. A method in claim 13, wherein the operations further comprise:
receiving, via a second user interface, a change to the definition of the business process, the change comprising one or more of rearrangement of an order of two or more of the plurality of process steps, addition of a new process step, deletion of one of the plurality of process steps, and re-definition of an aspect of one of the plurality of process steps; and
saving the change to the definition.

17. A method in claim 16, wherein the definition comprises a business object stored in a database, the business object comprising a template of a standard version of the business process, and the change is stored as an extension to the business object.

18. A method in claim 13, wherein the current status comprises at least one of which process steps have already been already performed for the selected instance of the business process, a link to a concrete instance of at least one business objects containing data relevant to one or more process steps or sub-processes of the selected instance of the business process, a name or identity of one or more responsible users, and one or more users with supervisory roles or other gatekeeper roles relating to the business process.

19. A method in claim 13, wherein at least one of the accessing, the displaying, of the work frame and the business process guidance frame, the receiving, and the displaying in the work frame are performed by at least one programmable processor.
